(19) United States
(12) Patent Application Publication
(10) Pub. No.: US 2004/0044960 A1
(43) Pub. Date: Mar. 4, 2004

(54) System and method for creating efficient markup based language transactions

(76) Inventor: Quenton Lanier Gilbert, Atlanta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/235,013

(22) Filed: Sep. 4, 2002

(51) Int. Cl. G06F 15/00

(52) U.S. Cl. 715/513

(57) ABSTRACT

A method of enhancing the efficiency of markup language files. The method comprises: reading the markup language file; scanning the markup language file to find at least one element type; associating a token with the found element type; replacing the element type in the markup language file with the token; and generating a token list comprising the token and its associated element type.

### FIELD OF THE INVENTION

This invention relates to the field of data communication, and more particularly, to a system and method for enhancing the efficiency of markup based languages, such as Extensible Markup Language (XML).

### BACKGROUND OF THE INVENTION

Markup languages, such as Hypertext Markup Language (HTML) and XML, are often used to conduct transactions over computer networks, such as the Internet. In the case of HTML, the language facilitates the proper display of information from a server platform to a client platform. HTML is generally a presentation language permitting information to be displayed in comparable formats on multiple types of client platforms. In contrast, XML provides a mechanism to store data, describe the data's content, and exchange data between data sources, for example between a database server and a database client. XML was created to provide the advantageous ability to store data while simultaneously describing its content.

However, the very nature of XML, that is the ability to describe the data as well as store the data, makes XML an incredibly verbose language. Not only is the language verbose, but, as those skilled in the art will appreciate, the language creates a great deal of redundant data. For example, the following code illustrates a sample XML document describing a list of books:

<library >

<book identifier = “bk001”>

<title>Helpful Hints About XML</title>
<author>

<firstname>Frank</firstname>
<lastname>Fielding</lastname>

</author>
<publication_date>01-01-2002</publication_date>

</book>
<book identifier = “bk002”>

<title>XML Four Dummies</title>
<author>

<firstname>Bob</firstname>
<lastname>Smith</lastname>

</author>
<publication_date>02-01-2001</publication_date>

</book>
<book identifier = “bk001”>

<title>Why XML?</title>
<author>

<firstname>Charles</firstname>
<lastname>Oakston</lastname>

</author>
<publication_date>03-12-2001</publication_date>

</book>

</library>

As can be seen from the above example of XML code, field descriptors, such as firstname, lastname, author, etc., are repeated throughout the example for each and every data entry. When transferring this code over a network, this repetitive data must be sent across the data connection using a great deal of bandwidth in transmitting redundant information.

Embodiments of the present invention are directed at overcoming one or more of the above limitations of the prior art.

### SUMMARY OF THE INVENTION

In accordance with the invention, a method of enhancing the efficiency of markup language files is provided. The method comprises: reading the markup language file; scanning the markup language file to find at least one element type; associating a token with the found element type; replacing the element type in the markup language file with the token; and generating a token list comprising the token and its associated element type.

In accordance with additional embodiment of the invention, a method of detokenizing a tokenized markup language file is provided. The method comprises: reading a tokenized markup language file; replacing the tokens within the tokenized markup language file with the token's respective associated element type; and storing the processed tokenized markup language file as a markup language file.

Further embodiments of the invention provide a system for enhancing the efficiency of a markup language file, comprising: memory for storing the markup language file; and a processor coupled to the memory. The processor may be operable to: read the markup language file; scan the markup language file to find at least one element type; associate a token with the found element type; replace the element type in the markup language file with the token; and generate a token list comprising the token and its associated element type.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is an overview of the flow of an XML document in an exemplary embodiment of the present invention.

FIG. 2 is an exemplary markup language file in XML format which may be processed by an exemplary embodiment of the present invention.

FIG. 3 is an exemplary tokenized markup language file in XML format following processing by an exemplary embodiment of the present invention.

FIG. 4 is a flowchart of an efficiency enhancing tokenizing method consistent with the present invention.

FIG. 5 is a flowchart of an efficiency enhancing detokenizing method consistent with the present invention.

FIG. 6 is a flowchart of the tokenizing process in an exemplary embodiment of the present invention.

FIG. 7 is a flowchart of the detokenizing process in an exemplary embodiment of the present invention.

FIG. 8 illustrates a system environment in which the features and principles of the present invention may be implemented.

### DESCRIPTION OF THE EMBODIMENTS

Reference will now be made in detail to the present exemplary embodiment of the invention, an example of which is illustrated in the accompanying drawings. Wherever possible, the same reference numbers will be used throughout the drawings to refer to the same or like parts.

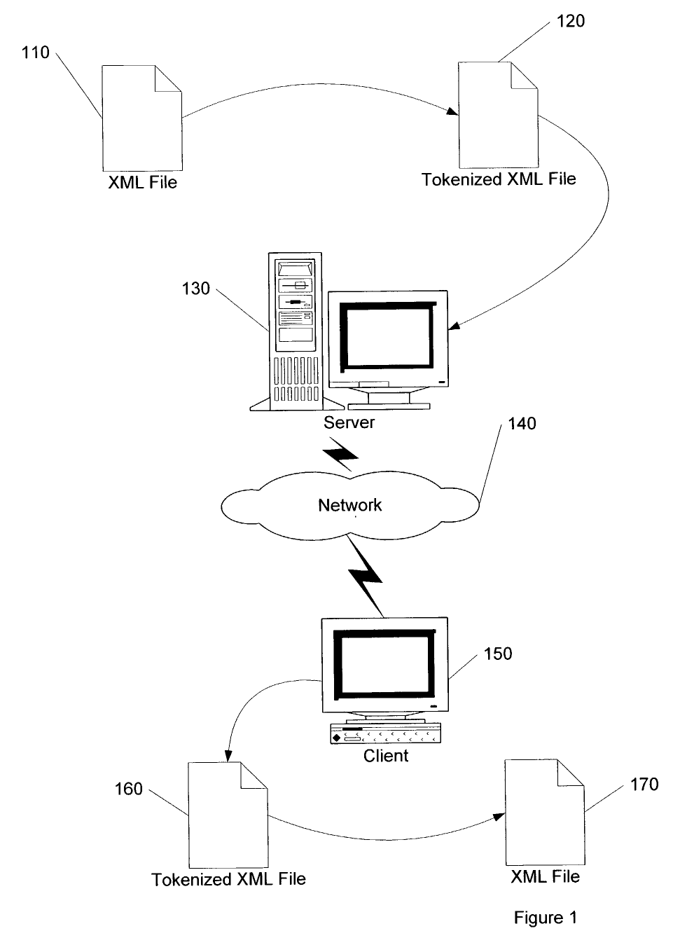

While the principles of the present invention are applicable to any type of markup language, for illustrative purposes this specification will provide examples relating to XML data files. FIG. 1 is an overview of the flow of an XML document in an exemplary embodiment of the present invention. An XML file 110 may be stored in memory accessible to a server 130. The memory may comprise RAM or ROM memory or some type of magnetic or optical storage media such as a hard drive, tape drive, or optical drive, for example. The server 130, or some other computing platform, tokenizes the XML file 110 into a tokenized XML file 120. Tokenization removes one or more redundant element types from within the XML file 110 to create the tokenized XML file 120. This tokenized XML file 120 is usually smaller than the original XML file 110. Server 130 then serves the tokenized XML file 120 via a network 140 to a client 150.

By reducing the size of the original XML file 110 to the size of the tokenized XML file 120, the bandwidth and time required to transmit the contents of the original XML file 110 are reduced. This reduction comes with no loss in the quality of the original data.

Client 150 receives the tokenized XML file 160, comparable to the tokenized XML file 120. Client 150, or another computing platform, may detokenize the XML file 160, restoring the tokenized XML file 160 to the original XML file 170. XML file 170 is now comparable to XML file 110 and may be stored, processed, or displayed, for example.

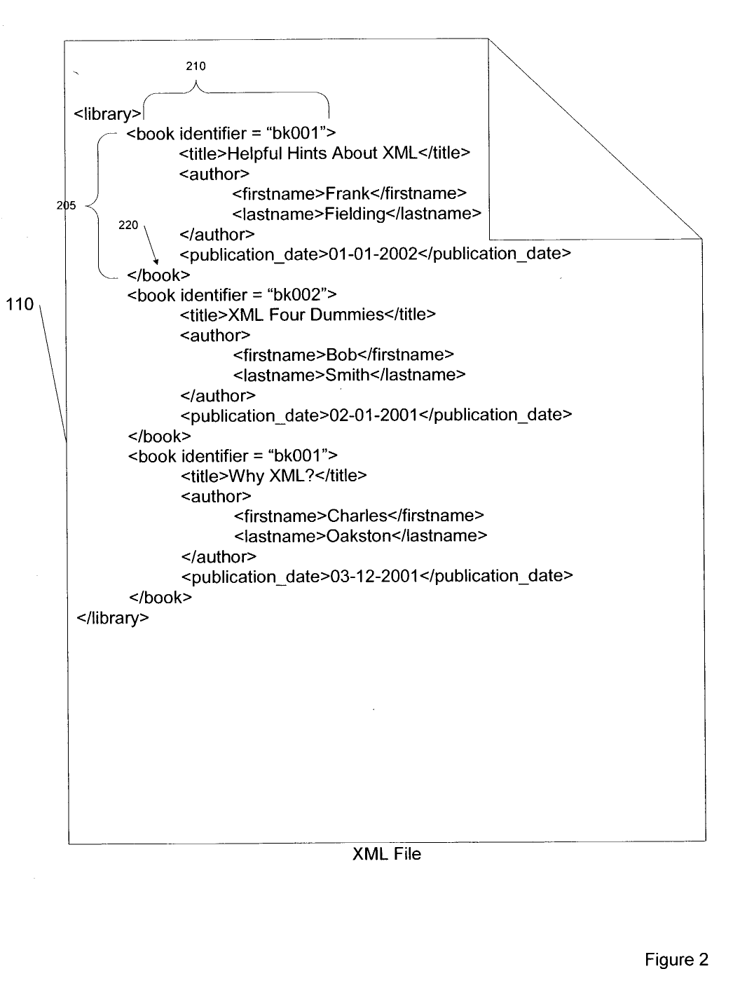

FIG. 2 is an exemplary markup language file in XML format 110 which may be processed by an exemplary embodiment of the present invention. Those skilled in the art familiar with XML should require little assistance in understanding the document 110. As in most markup languages, elements are delimited by start tags and stop tags. For example, book element 205 is delimited by start tag 210 and stop tag 220. This XML file 110 has a number of elements and element types depicted. Element types include book, title, author, firstname, lastname, and publication date. Each element on the page is a particular element type.

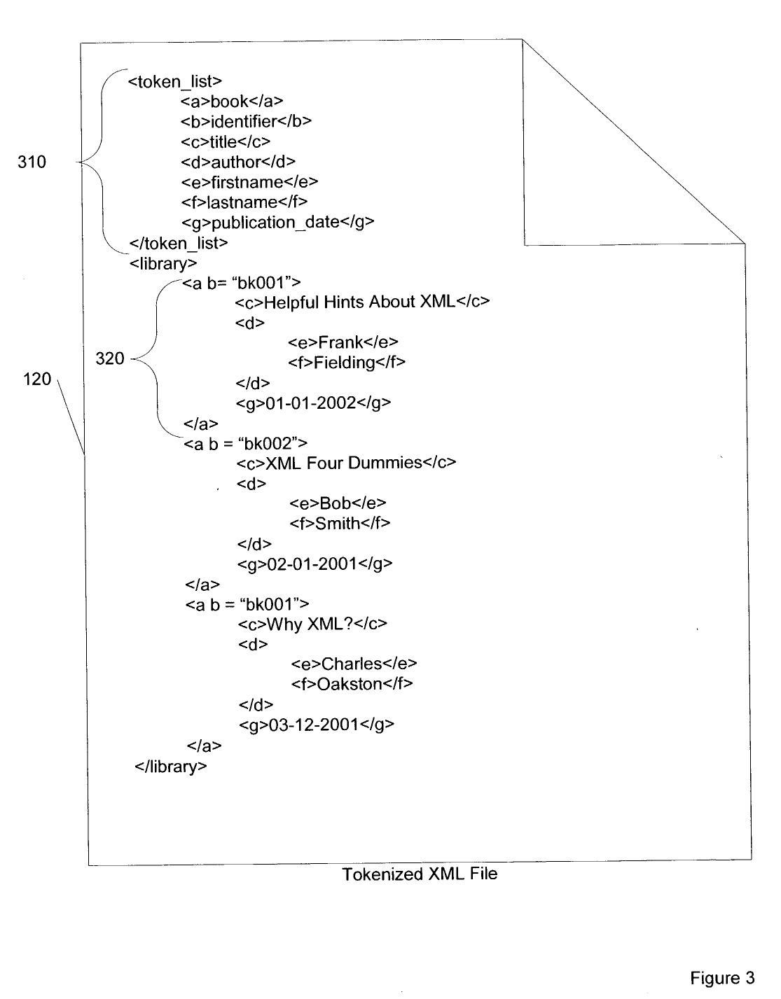

FIG. 3 is an exemplary tokenized markup language file in XML format following processing by an exemplary embodiment of the present invention. Embodiments of the present invention operate to replace the repetitive, verbose element types with simple, short tokens. A token list is then placed in the tokenized XML file to allow a detokenizer to restore the original XML file. Token list 310 is a token_list element type containing a listing of tokens with corresponding original element types. In this example, the token list denotes that element type “book” is replaced by token “a”. Similarly, element type “title” is replaced by “c”. Examination of tokenized XML file 120 illustrates the results of the tokenization process. Tokenized element 320 illustrates the savings that result as a consequence of tokenization.

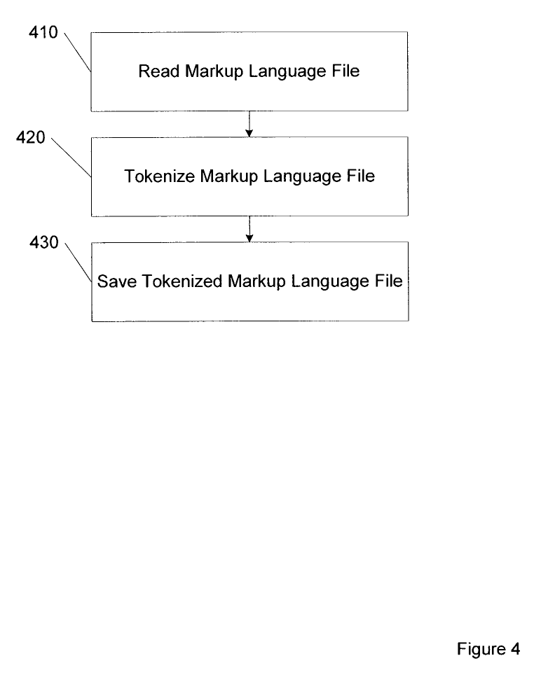

FIG. 4 is a flowchart of an efficiency enhancing tokenizing method consistent with the present invention. At stage 410, the markup language file is read into the processor. At stage 420, the processor tokenizes the markup language file by finding one or more element types, replacing the one or more element types by a respective token throughout the markup language file, and creating a token list of element types corresponding to respective tokens. At stage 430, the tokenized markup language file may be saved to a file or stored in memory for later use.

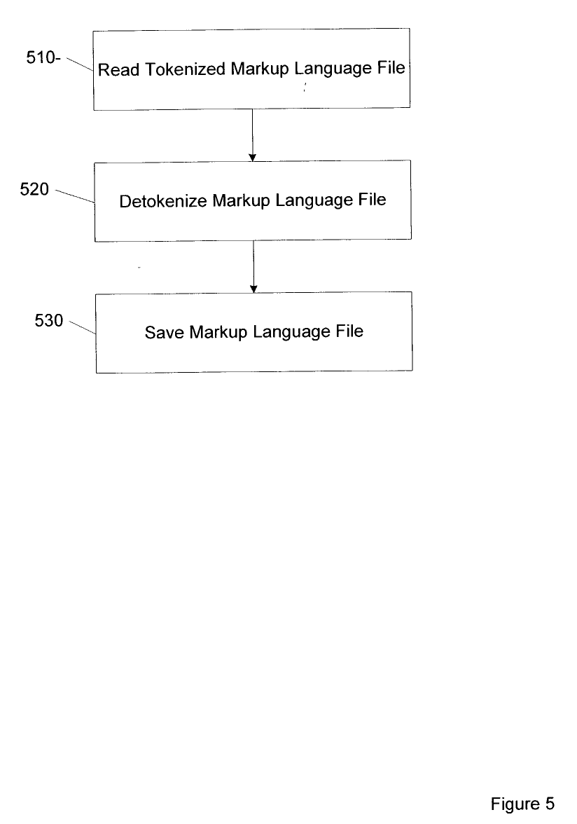

FIG. 5 is a flowchart of an efficiency enhancing detokenizing method consistent with the present invention. When a tokenized markup language file is received, it may be processed to restore the original non-tokenized markup language file. At stage 510, the tokenized markup language file is read by the processor. At stage 520, the processor detokenizes the markup language file. This process may involve reading one or more tokens from the token list and replacing each incidence of a token with a corresponding element type from the token list. At stage 530 the restored non-tokenized markup language file is saved to a file or stored in memory.

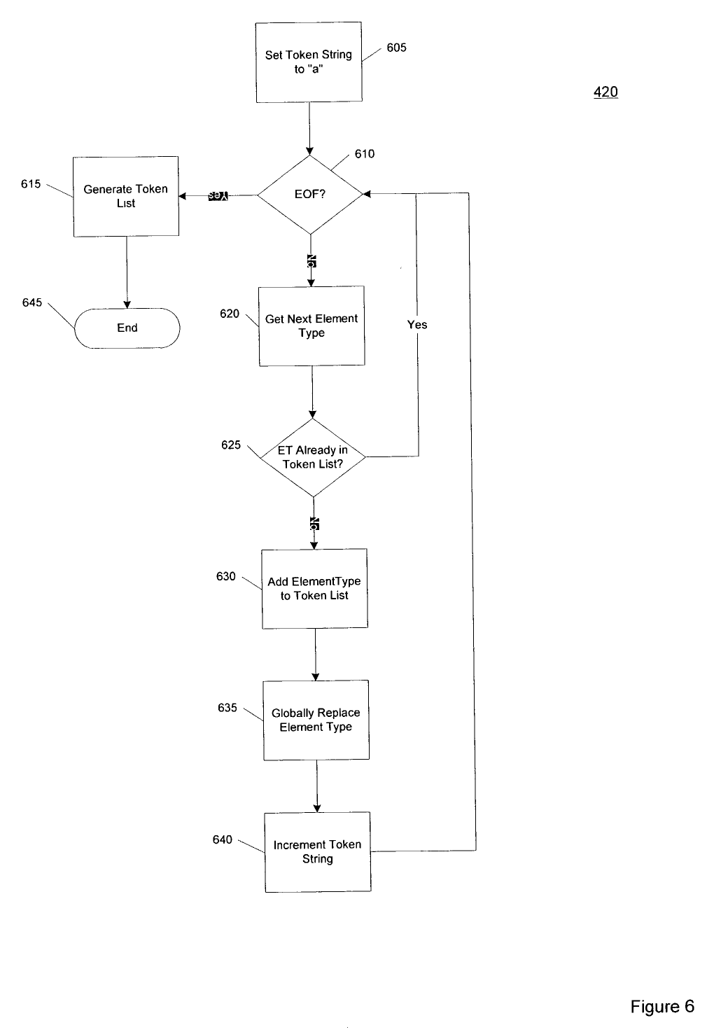

FIG. 6 is a flowchart of the tokenizing process 420 in an exemplary embodiment of the present invention. At stage 605, the token string is set to an initial value, such as “a”. During the course of the tokenizing process 420, the token string will be incremented as each token is used. While an exemplary embodiment of the present invention is illustrated as using the alphabet as a token string, other characters or string sequences may be used.

At stage 610, a check is made to see if the input markup language file is at the End of File (EOF). If the EOF has been reached, i.e., no further element types are to be found in the file, then flow proceeds to stage 615 where a token list is generated and placed within the output tokenized markup language file. If the EOF has not been reached, flow proceeds to stage 620 where the next element type is found within the input markup language file.

At stage 625, a test is made to see whether the element type already exists in the token list. If the element type is already in the token list, flow returns to stage 610. If the element type is not in the token list, flow proceeds to stage 630. At stage 630, the new element type is added to the element list and associated with the current value of the token string. At stage 635, the element type is globally replaced through the input markup language file with the associated token. At stage 640, the token string is incremented and flow returns to stage 610.

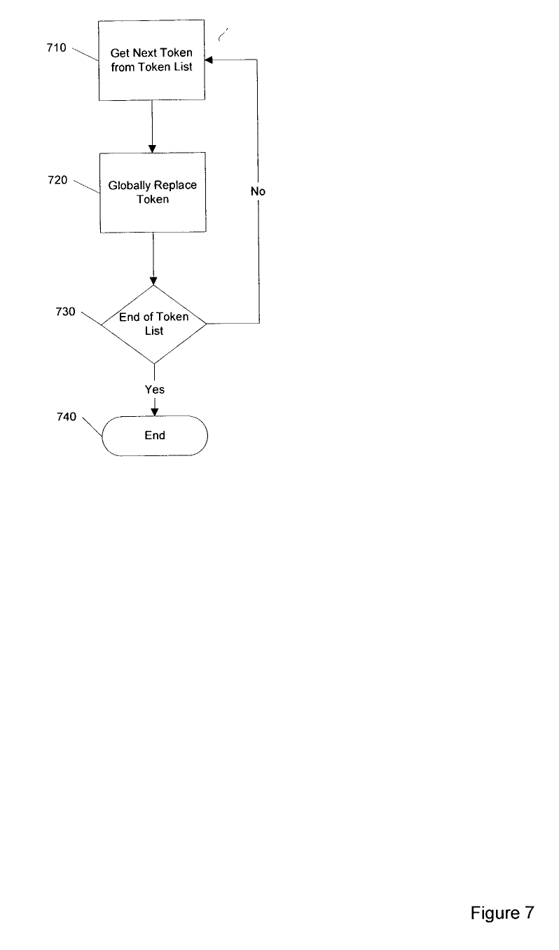

FIG. 7 is a flowchart of the detokenizing process in an exemplary embodiment of the present invention. When a tokenized markup language file needs to be utilized, detokenizer process 520 returns the tokenized markup language file to its original nontokenized state. At stage 710, the next token is removed from the token list. At stage 720, the element type associated with the token is used to globally replace the token within the tokenized markup language file. At stage 730, a test is made as to whether any more tokens exist in the token list. If so, flow returns to stage 710. If not, the process is complete at stage 740.

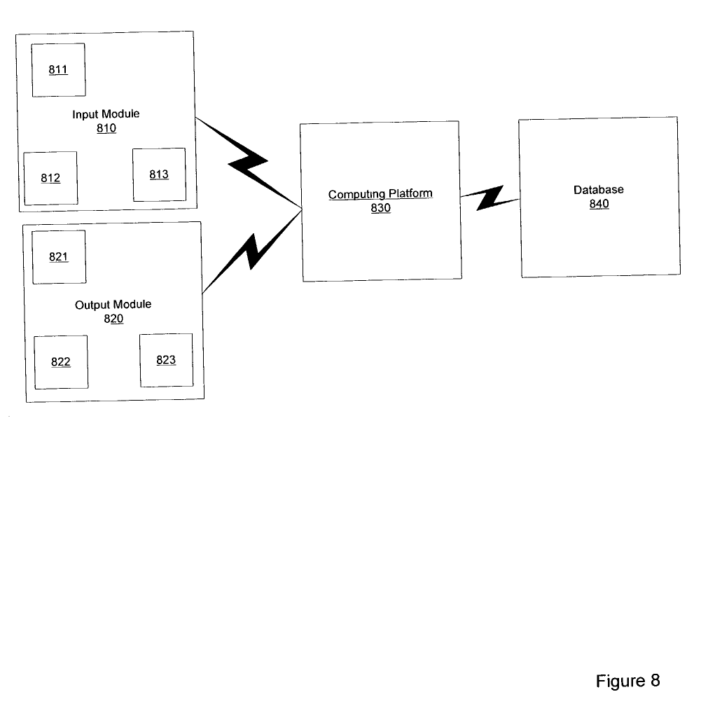

A hardware platform capable of implementing the system and method is now illustrated. By way of a non-limiting example, FIG. 8 illustrates a system environment in which the features and principles of the present invention may be implemented. As illustrated in the block diagram of FIG. 8, a system environment consistent with an embodiment of the present invention may include an input module 810, an output module 820, a computing platform 830, and a database 840. Computing platform 830 is adapted to include the necessary functionality and computing capabilities to implement tokenizing or detokenizing through input module 810 and access, read and write to database 840. The results may be provided as output from computing platform 830 to output module 820 for printed display, viewing, or further communication to other system devices. Such output may include, for example, one or more XML files. Output from computing platform 830 can also be provided to database 840, which may be utilized as a persistent storage device for storing, for example, XML files.

In the embodiment of FIG. 8, computing platform 830 may comprise a PC or mainframe computer for performing various functions and operations of the invention. Computing platform 830 may be implemented, for example, by a general purpose computer selectively activated or reconfigured by a computer program stored in the computer, or may be a specially constructed computing platform for carrying-out the features and operations of the present invention. Computing platform 830 may also be implemented or provided with a wide variety of components or subsystems including, for example, one or more of the following: one or more central processing units, a co-processor, memory, registers, and other data processing devices and subsystems. Computing platform 830 also communicates or transfers XML files to and from input module 810 and output module 820 through the use of direct connections or communication links, as illustrated in FIG. 8. In the exemplary embodiment of the invention, a firewall prevents access to the platform by unpermitted outside sources.

Alternatively, communication between computing platform 830 and modules 810, 820 can be achieved through the use of a network architecture (not shown). In the alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or a shared network architecture, computing platform 830 may be located in the same location or at a geographically distant location from input module 810 and/or output module 820.

Input module 810 of the system environment shown in FIG. 8 may be implemented with a wide variety of devices to receive and/or provide the data as input to computing platform 830. As illustrated in FIG. 8, input module 810 includes an input device 811, a storage device 812, and/or a network 813. Input device 811 may include a keyboard, a mouse, a disk drive, video camera, magnetic card reader, or any other suitable input device for providing customer data to computing platform 830. Memory device may be implemented with various forms of memory or storage devices, such as read-only memory (ROM) devices and random access memory (RAM) devices. Storage device 812 may include a memory tape or disk drive for reading and providing XML data on a storage tape or disk as input to computing platform 820. Input module 810 may also include network interface 813, as illustrated in FIG. 8, to receive data over a network (such as a LAN, WAN, intranet or the Internet) and to provide the same as input to computing platform 830. For example, network interface 813 may be connected to a public or private database over a network for the purpose of receiving XML files from computing platform 830.

As illustrated in FIG. 8, output module 820 includes a display 821, a printer device 822, and/or a network interface 823 for receiving the results provided as output from computing module 820. As indicated above, the output from computing platform 830 may include one or more tokenized or detokenized XML files. The output from computing platform 830 may be displayed or viewed through display 821 (such as a CRT or LCD) and printer device 822. If needed, network interface 823 may also be provided to facilitate the communication of the results from computer platform 830 over a network (such as a LAN, WAN, intranet or the Internet) to remote or distant locations for further analysis or viewing.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of enhancing the efficiency of markup language files, comprising:
reading the markup language file;
scanning the markup language file to find at least one element type;
associating a token with the found element type;
replacing the element type in the markup language file with the token; and
generating a token list comprising the token and its associated element type.

2. The method of claim 1, further comprising:
repeating the scanning, associating, and replacing stages until all element types within the markup language file have been found, associated with respective tokens, and replaced with respective tokens.

3. The method of claim 2, further comprising:
generating a token list comprising all tokens and each token's associated element type.

4. The method of claim 1, further comprising storing the processed markup language file as a tokenized markup language file.

5. The method of claim 4, further comprising transmitting the tokenized markup language file across a network.

6. A method of detokenizing a tokenized markup language file, comprising:
reading a tokenized markup language file;
replacing the tokens within the tokenized markup language file with the token's respective associated element type; and
storing the processed tokenized markup language file as a markup language file.

7. A system for enhancing the efficiency of a markup language file, comprising:
memory for storing the markup language file; and
a processor coupled to the memory, the processor operable to:
read the markup language file;
scan the markup language file to find at least one element type;
associate a token with the found element type;
replace the element type in the markup language file with the token; and
generate a token list comprising the token and its associated element type.
